(19) United States
(12) Patent Application Publication
(10) Pub. No.: US 2009/0223292 A1
(43) Pub. Date: Sep. 10, 2009

(54) ACCELERATION SENSOR

(75) Inventors: Hiroyuki Hatano, Mohka (JP); Atsushi Mieno, Mohka (JP); Masakatsu Saitoh, Yokohama (JP); Yoshio Ikeda, Oyama (JP)

Correspondence Address: SUGHRUE MION, PLLC, 2100 PENNSYLVANIA AVENUE, N.W., SUITE 800, WASHINGTON, DC, 20037, US

(73) Assignee: Hitachi Metals, Ltd., Minato-ku, Tokyo (JP)

(21) Appl. No.: 12/375,476

(22) PCT Filed: Sep. 18, 2007
(86) PCT No.: PCT/JP2007/068048

§ 371 Date: Jan. 28, 2009

(30) Foreign Application Priority Data
Sep. 28, 2006 (JP) 2006-265110
Feb. 2, 2007 (JP) 2007-024646

(51) Int. Cl. G01P 15/12

(52) U.S. Cl. 73/514.33

(57) ABSTRACT

Provided is a piezo-resistor type acceleration sensor in which an offset voltage does not fluctuate even when excessive impact/acceleration is applied. In the acceleration sensor, metal wires on top surfaces of a flexible portion and a weight are arranged in grooves formed on the flexible portion top surface/weight top surface. The acceleration sensor has a structure in which the metal wires do not hit an upper regulation plate even when the weight collides with the upper regulation plate, and the offset voltage fluctuation can be avoided.

### TECHNICAL FIELD

The present invention relates to a piezo-resistor type acceleration sensor for detecting acceleration for use in automobiles, aircraft, home electric appliances, game machines, robots, security systems and the like.

### BACKGROUND ART

Acceleration sensors have been used for purposes of detecting a large impact force for deploying an automotive air-bag and detecting a small acceleration for a vehicle control application such as a brake control system. For these automotive applications, an acceleration sensor with a one-axis or two-axis function is enough because only accelerations in the directions of the X-axis and/or Y-axis are measured. Recently, acceleration sensors have been put into practical use for new applications such as mobile terminal units, robots or various controls utilizing detection of movements of a human body. For these new applications, a three-axis acceleration sensor that can measure acceleration in the X-axis, the Y-axis, and the Z-axis is required in order to detect three-dimensional movement. Moreover, the three-axis acceleration sensor is also required to have high resolution to detect slight acceleration and have a small-sized thin profile.

Acceleration sensors are roughly classified as piezo-resistor type, capacitance type or piezoelectric type according to a way of converting movements of a flexible portion therein into electrical signals. Which of these types is used depends on the application, and for the purpose of detecting static acceleration, piezo-resistor type and capacitance type are employed. In these two types, a number of small-sized high sensitivity acceleration sensors can be produced at once by forming a three-dimensional structure on a silicon substrate with semiconductor technologies and micromachine technologies. In particular, an acceleration sensor of the piezo-resistor type allows easy construction of the structure and the manufacturing process, has a small-sized thin profile, and is suitable for price-reduction. Moreover, acceleration sensors are roughly classified as diaphragm type or beam (flexible arm) type according to the structure of the flexible portion. The ways of detecting electrical signals, the structures of the flexible portion and the number of detection axes may be combined to obtain various acceleration sensors.

There are many patent applications in relation to a piezo-resistor type three-axis acceleration sensor having flexible arms. Patent Documents 1 to 6 disclose a shape of a weight and flexible arms, an arrangement of piezo-resistors, connections of the piezo-resistors, a shape of a connection between the flexible arm and a support frame, and the like. In the three-axis acceleration sensor, a sensor chip and an upper regulation plate are spaced apart by a predetermined distance and adhered in a case thereof with an adhesive such as resin. A case lid is hermetically adhered on the case, for example, with an adhesive such as gold tin solder. The three-axis acceleration sensor element having the flexible arms is formed in the sensor chip, and the three-axis acceleration sensor element is constituted of a rectangular support frame, a weight and paired flexible arms, in which the weight is held in the center of the support frame with two pairs of flexible arms. Piezo-resistors are formed on the flexible arms. One pair of flexible arms has X-axis piezo-resistors and Z-axis piezo-resistors formed thereon, and the other pair of flexible arms has Y-axis piezo-resistors formed thereon, the resistors being connected to metal wires. A distance between an undersurface of the weight and an inner bottom surface of the case as well as a distance between a top surface of the weight and the upper regulation plate restrict a movement of the weight to prevent the thin flexible arms from breaking down when an excessive acceleration such as an impact is applied to the acceleration sensor.

Patent Documents 7 to 9 disclose a diaphragm structure of a three-axis acceleration sensor with a diaphragm, and an arrangement of piezo-resistors. As a flexible portion, a circular or polygonal diaphragm is attached to a support frame at outer edge of the diaphragm, and a weight is arranged at an inner edge of the diaphragm. When the weight is displaced by an external force, piezo-resistors provided in the diaphragm are deformed, so that an electric signal is obtained. Compared with a beam-type three-axis acceleration sensor element, the three-axis acceleration sensor with the diaphragm has an advantage of having a high degree of freedom for the arrangement of the piezo-resistors. The three-axis acceleration sensor with the diaphragm is constituted of a square support frame, a weight and a diaphragm, and the weight is held in the center of the diaphragm. In the diaphragm, piezo-resistors (X-axis piezo-resistors, Y-axis piezo-resistors and Z-axis piezo-resistors) are formed and connected to metal wires.

When the weight is moved under an external force, the flexible portion is deformed. The deformation of the flexible portion can be measured as a change in resistance of the piezo-resistor to determine the direction and magnitude of the external force. However, since the change in resistance of the piezo-resistor is slight, a full bridge circuit with four piezo-resistors arranged for each axis on the flexible portion is formed to detect such a slight change in resistance as a change in voltage. If the four piezo-resistors constituting the full bridge have equal electric resistance, there is no output from the bridge. However, an output of the bridge practically appears even with no acceleration applied or with no deformation of the flexible portion since the four piezo-resistors have different resistance due to various factors such as variations of an impurity concentration of the piezo-resistor, variations in dimension of the element, a difference in stresses applied to the element between the four piezo-resistors. This output voltage is referred to as an offset voltage. By providing an adjustment circuit in the acceleration sensor, the offset voltage is canceled to reduce the offset voltage to substantially zero.

In an effect confirmation test of the regulation plate, when an excessive impact was applied to the acceleration sensor, the offset voltage in excess of an allowable range may occur in such an acceleration sensor whose offset voltage is adjusted. This is attributed to the fact that the excessive impact applied to the acceleration sensor causes the flexible portion to collide with the upper regulation plate, deforming a part of metal wires provided in the flexible portion. A change in the electric resistance resulting from deformation in the metal wires causes an offset voltage.

In Patent Document 10, it is proposed to divide a piezo resistor into a plural of piezo sub-resistors to increase detection sensitivity without affecting electrical power consumption and impact resistance. For example, by dividing one piezo-resistor into two piezo sub-resistors and connecting the two piezo sub-resistors having the same width in series, the same resistance as one piezo-resistor can be obtained. By arranging two half-length piezo sub-resistors next to each other in a stress concentration zone of the flexible portion, the detection sensitivity thereof can be increased even when the flexible portion is deformed likewise. Dividing a piezo-resistor into a plural of piezo sub-resistors does not change resistance thereof, and therefore, detection sensitivity thereof can be increased while electrical power consumption thereof is not changed. However, since its division increases the number of the metal wires connecting the piezo sub-resistors, the metal wires collide with the upper regulation plate to be deformed, so that occurrence of the offset voltage is also increased.

It is possible to coat the metal wires thickly with a rigid and electrically insulating film such as alumina and silicon oxide such that the metal wires are not deformed even when the flexible portion collides with the upper regulation plate. However, when such film is thickly formed, the degree of deformation of the flexible portion is changed. The flexible portion is constituted of silicon and formed of a material with a coefficient of thermal expansion different from that of the electrically insulating film and the metal wires. Stresses applied to the piezo-resistors vary due to a difference between coefficients of thermal expansion of constituent materials, which is one of the causes of occurrence of the offset voltage. Further, when the metal wire is thickly covered with the rigid and electrically insulating film, the offset voltage is further increased.
Patent Document 1: JP 2003-172745 A
Patent Document 2: JP 2003-279592 A
Patent Document 3: JP 2004-184373 A
Patent Document 4: JP 2006-098323 A
Patent Document 5: JP 2006-098321 A
Patent Document 6: WO 2005/062060 A1
Patent Document 7: JP Hei 3-2535 A
Patent Document 8: JP Hei 6-174571 A
Patent Document 9: JP Hei 7-191053 A
Patent Document 10: JP 2006-098321 A

### DISCLOSURE OF THE INVENTION

### Problems to be Solved by the Invention

The present invention has been made to solve the above-mentioned problems, and has an object to provide a small-sized thin three-axis acceleration sensor in which an offset voltage does not newly occur even if an excessive impact is applied after an adjustment of offset voltage.

### Means for Solving the Problems

An acceleration sensor according to the present invention comprises: a weight in a center of the acceleration sensor; a support frame surrounding the weight and being at a predetermined distance from the weight; a flexible portion bridging an upper portion of the weight and an upper portion of the support frame and hanging the weight; a plurality of piezo-resistors formed in the flexible portion and adjacent to a top surface of the flexible portion; sensor terminals provided on a top surface of the support frame; and metal wires connecting between the piezo-resistors or between the piezo-resistors and the sensor terminals. A part of the metal wires disposed on the flexible portion is put in a groove having a rectangular cross-section or an inverted trapezoidal cross-section formed on the top surface of the flexible portion, and top surfaces of the metal wires put in the groove formed on the top surface of the flexible portion are lower than the top surface of the flexible portion.

In the acceleration sensor of the present invention, it is desirable that the metal wires which a top surface of the weight has is put in a groove having a rectangular cross-section or an inverted trapezoidal cross-section formed on the top surface of the weight, and top surfaces of the metal wires put in the groove formed on the top surface of the weight are lower than the top surface of the weight.

In the acceleration sensor of the present invention, it is desirable that a part of the metal wires which is on a weight side from an end on a support frame side of a piezo-resistor disposed on the support frame side among the plurality of piezo-resistors has a top surface lower than the top surface of the flexible portion.

In the acceleration sensor of the present invention, top surfaces of the metal wires put in the groove formed on the top surface of the flexible portion are preferably 0.05 μm to 0.5 μm lower than the top surface of the flexible portion. A top surface of the metal wires disposed in the groove formed on the top surface of the weight is preferably at least 0.05 μm lower than the top surface of the weight.

In the acceleration sensor of the present invention, it is preferable that the flexible arms are composed of a silicon layer and an electrically insulating layer covering the silicon layer, and that the electrically insulating layer covers the top surface of the flexible portion and both inner side walls and a bottom surface of the groove. The groove may be formed on the silicon layer. Alternatively, the groove formed on the top surface of the flexible portion may be formed in the electrically insulating layer covering the silicon layer.

In the acceleration sensor of the present invention, the weight preferably has a silicon layer and an electrically insulating layer covering the silicon layer, and the electrically insulating layer covers both inner side walls and a bottom surface of a groove formed on the top surface of the weight. The groove of the top surface of the weight may be formed on the top surface of the silicon layer. Alternatively, the groove of the top surface of the weight may be formed on the electrically insulating layer covering the silicon layer.

In the acceleration sensor of the present invention, the groove on the top surface of the flexible portion preferably extends to the top surface of the weight and to the top surface of the support frame. A plurality of metal wires may be formed in a part of the groove on the top surface of the weight or the support frame.

In the acceleration sensor of the present invention, it is preferable that the flexible portion is composed of a plurality of flexible arms bridging the upper portion of the weight and the upper portion of the support frame;
each of the plurality of flexible arms has at least one of the grooves formed on the flexible portion, is constituted of a silicon layer and an electrically insulating layer covering the silicon layer, and the electrically insulating layer covers both inner side walls and a bottom surface; and
each of the plurality of flexible arms is structurally symmetric with respect to a centerline extending in a longitudinal direction of the flexible arm. Each of the plurality of flexible arms may have at least two grooves, and the piezo-resistors may be located between the grooves on the silicon layer.

### Advantages of the Invention

In an acceleration sensor according to the present invention, since a metal wire disposed on a top surface of a flexible portion bridging a weight and a support frame is placed in a groove formed on the top surface of the flexible portion as well as a top surface of the metal wire is lower than the top surface of the flexible portion, the metal wire does not collide with an upper regulation plate when an excessive acceleration or impact is applied to the acceleration sensor. Accordingly, the metal wire does not deform and an offset voltage does not newly occur in the acceleration sensor.

### BRIEF DESCRIPTION OF DRAWINGS

FIG. 1 is an exploded perspective view of an acceleration sensor device comprising an acceleration sensor of EXAMPLE 1 according to the present invention;

FIG. 2 is a plan view of the acceleration sensor of EXAMPLE 1;

FIG. 3 is an enlarged plan view of one of flexible arms extending in the X-axis direction of the acceleration sensor of EXAMPLE 1;

FIG. 4 is an enlarged plan view of one of flexible arms extending in the Y-axis direction of the acceleration sensor of EXAMPLE 1;

FIG. 5 is an enlarged cross-sectional view taken along V-V line of FIG. 2;

FIG. 6 is an enlarged cross-sectional view taken along VI-VI line of FIG. 2;

FIG. 7 is an enlarged cross-sectional view taken along VII-VII line of FIG. 2;

FIG. 8 is an enlarged cross-sectional view taken along IIX-IIX line of FIG. 2;

FIG. 9 is an enlarged cross-sectional view taken along IX-IX line of FIG. 2;

FIG. 10 is an explanatory view of wires of the acceleration sensor of EXAMPLE 1;

FIG. 11 is an explanatory view of a full bridge circuit of X-axis piezo-resistors (Y-axis piezo-resistors) of FIG. 10;

FIG. 12 is an explanatory view of a full bridge circuit of Z-axis piezo-resistors of FIG. 10;

FIG. 13 is an enlarged plan view of two flexible arms extending in the Y-axis direction of an acceleration sensor of EXAMPLE 2;

FIG. 14 is an enlarged cross-sectional view taken along XIV-XIV line of FIG. 13;

FIG. 15 is an enlarged cross-sectional view of a flexible arm of an acceleration sensor of EXAMPLE 3 extending in the Y-axis direction;

FIG. 16 is a longitudinal sectional view taken along XVI-XVI line of FIG. 15;

FIG. 17 is a longitudinal sectional view taken along XVII-XVII line of FIG. 15; and

FIG. 18 is a plan view of an acceleration sensor of EXAMPLE 4.

### EXPLANATION OF REFERENCE NUMERALS

10: weight

11t, 12t, 13t, 14t, 21t, 23t, 31t, 33t: sensor terminal

16, 26, 26′, 36: groove

21, 21′, 21″, 22, 22′, 23, 23′: flexible arm

24: silicon layer

25, 25c, 25c′, 25d: metal wire

28, 28′: electrically insulating layer

29: diaphragm

30: support frame

X1, X2, X3, X4, Y1, Y2, Y3, Y4, Z1, Z2, Z3, Z4: piezo-resistor

### BEST MODE FOR CARRYING OUT OF THE INVENTION

Hereinafter, an acceleration sensor according to the present invention will be described in detail based on EXAMPLES with reference to drawings.

### Example 1

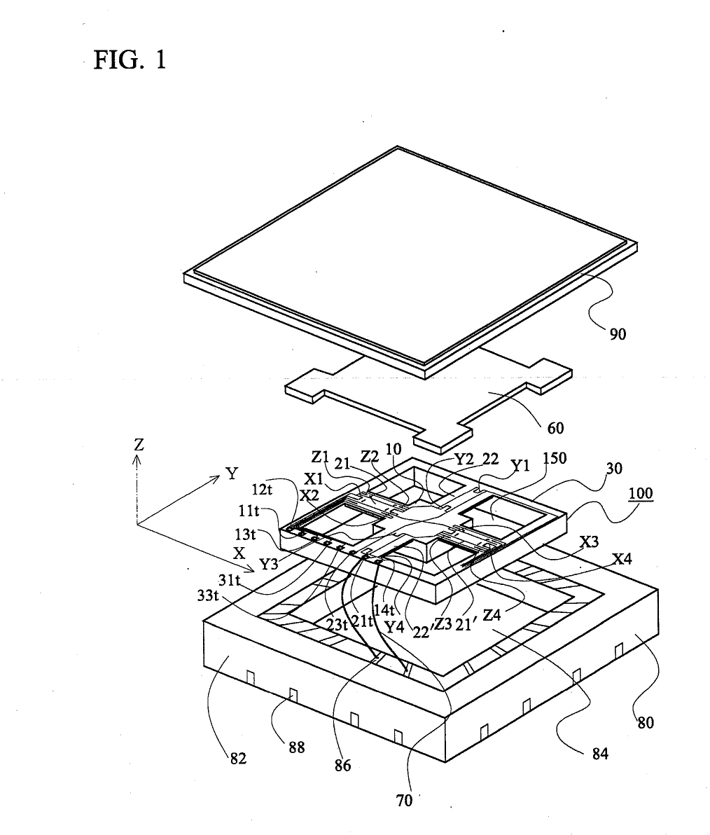

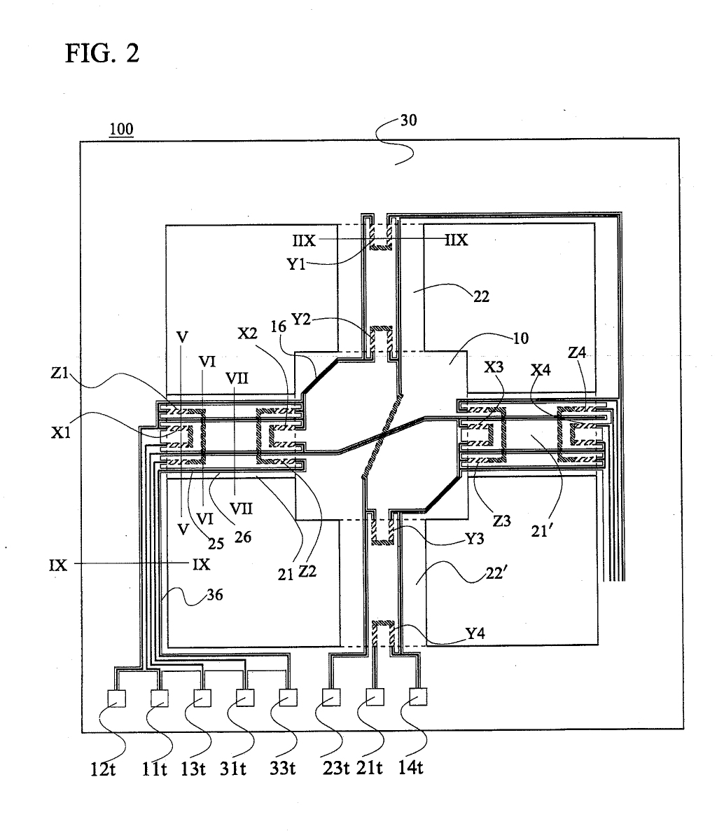

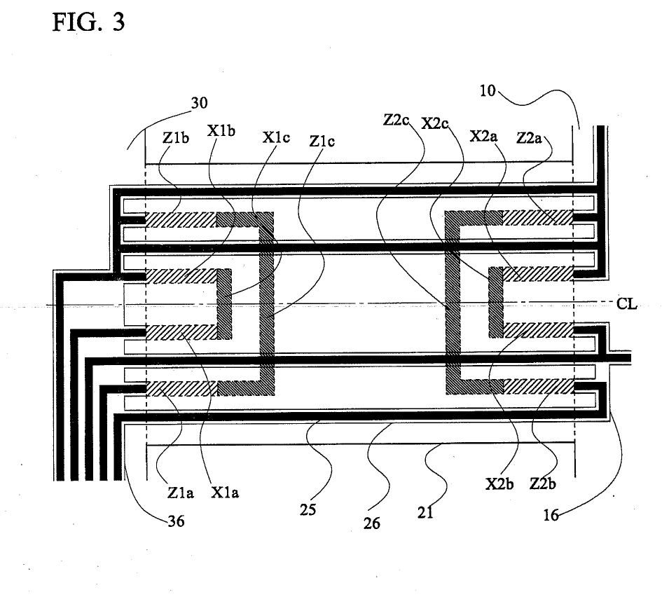

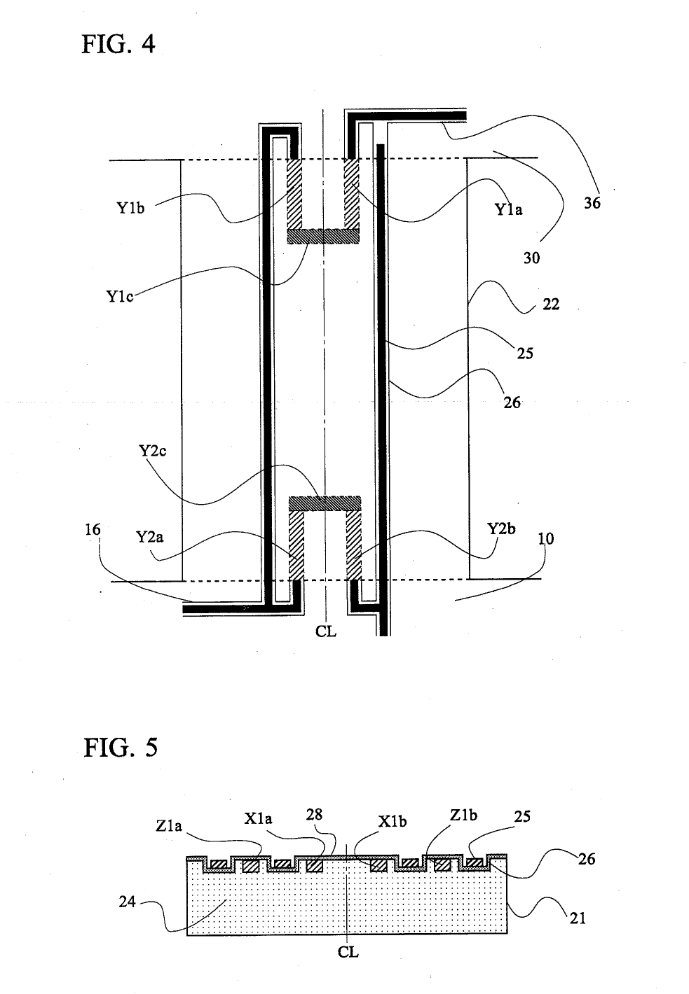

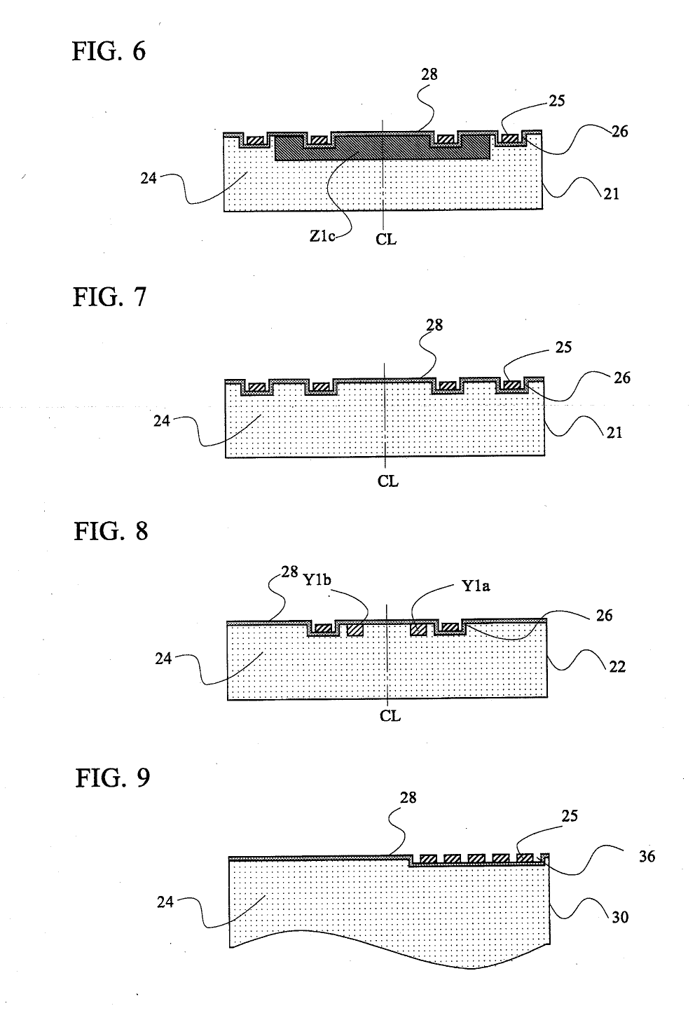

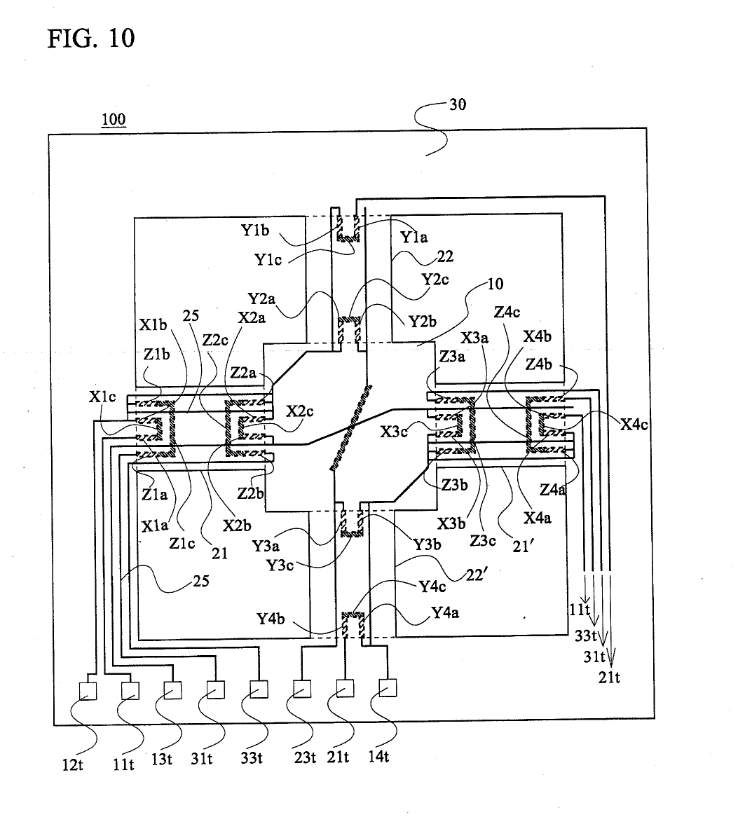

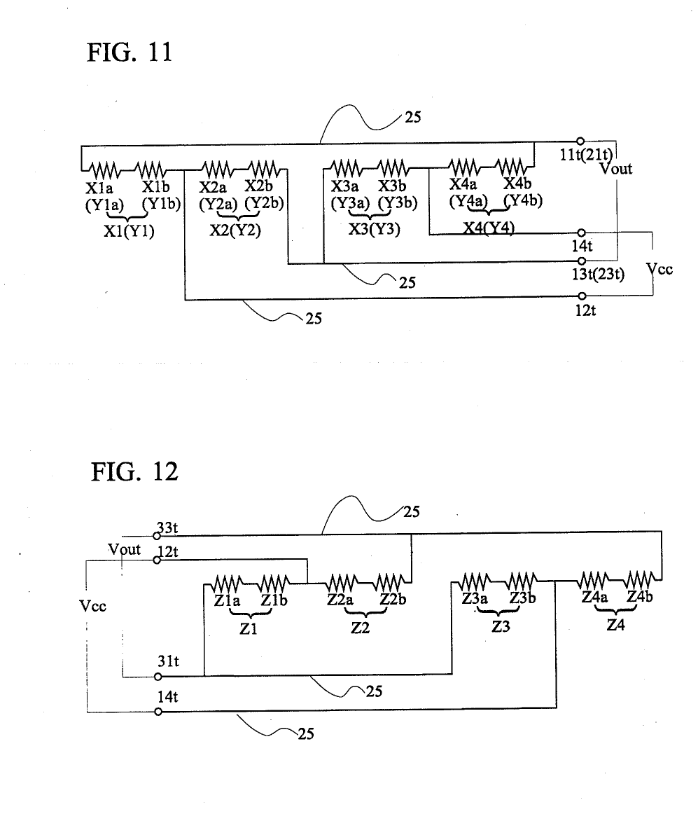

An acceleration sensor device having an acceleration sensor of EXAMPLE 1 according to the present invention will be described with reference to FIG. 1 to 12. FIG. 1 is an exploded perspective view of the acceleration sensor device of EXAMPLE 1 according to the present invention, FIG. 2 is a plan view of the acceleration sensor for the acceleration sensor device of EXAMPLE 1, FIG. 3 is an enlarged plan view of one of flexible arms extending in the X-axis direction of the acceleration sensor, FIG. 4 is an enlarged plan view of one of flexible arms extending in the Y-axis direction of the acceleration sensor, FIG. 5 is an enlarged cross-sectional view taken along V-V line of FIG. 2, FIG. 6 is an enlarged cross-sectional view taken along VI-VI line of FIG. 2, FIG. 7 is an enlarged cross-sectional view taken along VII-VII line of FIG. 2, FIG. 8 is an enlarged cross-sectional view taken along IIX-IIX line of FIG. 2, FIG. 9 is an enlarged cross-sectional view taken along IX-IX line of FIG. 2, FIG. 10 is an explanatory plan view of wires of the acceleration sensor of FIG. 2, FIG. 11 is an explanatory view of a full bridge circuit of X-axis piezo-resistors (Y-axis piezo-resistors) of FIG. 10, and FIG. 12 is an explanatory view of a full bridge circuit of Z-axis piezo-resistors of FIG. 10.

In an acceleration sensor device of FIG. 1, an acceleration sensor 100 is adhered in a case 80 over a case inner bottom surface 84 with a bottom of a support frame 30 of the acceleration sensor 100 separated from an inner bottom surface 84 by a small gap, in which a small gap between the case inner bottom surface 84 and a weight 10 of the acceleration sensor 100 is formed. Each of sensor terminals 12t, 11t, 13t, 31t, 33t, 23t, 21t, 14t of the acceleration sensor 100 is connected to a terminal 86 of the case 80 through a conductor 70, and the terminal 86 of the case is connected to an external terminal 88 of the case inside the case. A voltage for measurement is applied to piezo-resistors of the acceleration sensor 100 from the external terminal 88, or an output of the acceleration sensor 100 is taken out from the external terminal 88. An upper regulation plate 60 is attached over the acceleration sensor 100 so as to cover its whole surface, with the upper regulation plate 60 separated from the acceleration sensor 100 by a small gap, preventing an excessive vibration/movement of the weight 10. When an acceleration is applied to the weight 10, the weight 10 vibrates and moves if the acceleration is within a certain range, but when an excessive acceleration is applied, the weight dose not vibrate beyond the amount of the small gaps or more between it and the upper regulation plate 60 as well as between it and the case inner bottom surface 84. A case lid 90 is attached on the case 80.

The acceleration sensor 100 has the weight 10 in a center of the acceleration sensor 100, the support frame 30 surrounding the weight 10 and being at a predetermined distance from the weight 10, and a flexible portion bridging an upper portion of the weight and an upper portion of the support frame and hanging the weight 10. In this EXAMPLE, the acceleration sensor 100 has four flexible arms 21, 21′, 22, 22′ as the flexible portion. The acceleration sensor 100 is made of a silicon single crystal substrate with a SOI layer formed, i.e. a SOI wafer. The SOI is an abbreviation for Silicon On Insulator. In this EXAMPLE, a wafer, with a thin (for example, approximately 1 μm) SiO2 insulating layer serving as an etching stopper formed on the Si wafer having a thickness of approximately 410 μm and with an N-type silicon single crystal layer having a thickness of approximately 6 μm formed thereon, is used as a substrate. Four L-shaped through openings 150 are formed in the silicon single crystal substrate having a square shape that is as large as the support frame 30; the weight 10 in the center of the acceleration sensor 100, the support frame 30 surrounding the weight 10, and the flexible arms 21, 21′, 22, 22′ bridging therebetween are formed; as well as the thickness of a flexible arm portion therein is reduced.

The acceleration sensor 100 has piezo-resistors on the flexible arms and for each axis corresponding to two detection axes orthogonal to each other (the X-axis and the Y-axis) and a detection axis perpendicular to a top surface of the acceleration sensor (the Z-axis). Thus, piezo-resistors X1, X2, X3, and X4 are provided on the flexible arms 21, 21′ extending in the X-axis direction, which detect an X-component of acceleration. Piezo-resistors Y1, Y2, Y3, and Y4 are provided on the flexible arms 22, 22′ extending in the Y-axis direction, which detect a Y-component of acceleration. Further, piezo-resistors Z1, Z2, Z3, and Z4 are provided on the flexible arms 21, 21′ extending in the X-axis direction, which detect a Z-component of acceleration. In this EXAMPLE, though the Z-component of acceleration is detected by the piezo-resistors provided on the flexible arms 21, 21′, piezo-resistors for detecting the Z-component of acceleration may be provided on the flexible arms 22, 22′. The piezo-resistors for detecting each axis component of acceleration constitute full bridge detection circuits as shown in FIG. 11 or 12, respectively.

In the acceleration sensor 100 of this EXAMPLE, the piezo-resistors X1, . . . , X4, Y1, . . . , Y4, Z1, . . . , Z4 are respectively divided, so that divided piezo-resistors are constituted of piezo sub-resistors X1a, X1b, . . . , X4a, X4b, Y1a, Y1b, . . . , Y4a, Y4b, Z1a, Z1b, . . . , Z4a, Z4b. Since the flexible arms connecting the weight 10 and the support frame 30 highly deform in a region adjacent to the weight 10 or the support frame 30 when an acceleration is applied to the weight, in order to increase sensitivity to an acceleration, each piezo sub-resistor is provided in a region adjacent to a boundary between the flexible arm and the weight or adjacent to a boundary between the flexible arm and the support frame where the flexible arm highly deforms. Their arrangements are shown in FIG. 2, FIG. 3, FIG. 4 and FIG. 10. Each piezo sub-resistor is formed by implanting boron into the silicon layer constituting the flexible arms with its concentration of 1 to 3×10¹⁸ atoms/cm³. High concentration diffusion layers X1c, X2c, X3c, X4c, Y1c, Y2c, Y3c, Y4c, Z1c, Z2c, Z3c, and Z4c are formed so as to connect between terminals on the center side of the flexible arm of two piezo sub-resistors constituting each piezo-resistor. These high concentration diffusion layers are formed with a concentration higher than the piezo sub-resistor, e.g. of 1 to 3×10²¹ atoms/cm³ by implanting boron. Since the piezo sub-resistor and the high concentration diffusion layer are formed by diffusing boron into the silicon layer, their mechanical properties are exactly the same as that of other portion of the flexible arm. Two piezo sub-resistor X1a and X1b, . . . , Z4a and Z4b connected by the high concentration diffusion layers X1c, . . . , Z4c, respectively, constitute the piezo-resistors X1, . . . , Z4. The piezo-resistors X1, X2, X3, and X4 of the X-axis constitute a full bridge detection circuit as shown in FIG. 11, and a bridge output Vout is taken out from between the sensor terminals 11t and 13t by applying a measuring direct-current voltage Vcc between its sensor terminals 12t and 14t. The piezo-resistors Y1, Y2, Y3, and Y4 of the Y-axis constitute a full bridge detection circuit as shown in FIG. 11, and a bridge output Vout is taken out from between the sensor terminals 21t and 23t by applying the measuring direct-current voltage Vcc between its sensor terminals 12t and 14t. The piezo-resistors Z1, Z2, Z3, and Z4 of the Z-axis constitute a full bridge detection circuit as shown in FIG. 12, and a bridge output Vout is taken out from between the sensor terminals 31t and 33t by applying the measuring direct-current voltage Vcc between its sensor terminals 12t and 14t. FIG. 10 shows a plan view in which the piezo sub-resistors of the X-axis, the piezo sub-resistors of the Y-axis and the piezo sub-resistors of the Z-axis as well as the sensor terminals 11t, 12t, 13t, 14t, 21t, 23t, 31t, 33t are represented on the top surface of the acceleration sensor 100. Sensor terminals in FIGS. 11 and 12 correspond to sensor terminals as shown in FIG. 10, respectively. The metal wires 25 such as aluminum are connected between the terminals of these piezo-resistors or between the terminals of the piezo-resistors and the sensor terminals.

FIG. 2 shows a view similar to FIG. 10, but FIG. 2 represents that the metal wire 25 is placed, on the flexible arms 21, 21′, 22, 22′, in the groove 26 formed on the flexible arms 21, 21′ 22, 22′. Moreover, the metal wire 25 is placed, on the top surface of the support frame 30, in a groove 36 formed on the top surface of the support frame 30, as well as placed, on the weight 10, in the groove 16 formed on the top surface of the weight 10. FIG. 10 shows the same structure as that of FIG. 2, but illustrations of the grooves 16, 26, 36 are omitted in FIG. 10 to show reference characters of the piezo sub-resistors. FIGS. 3 and 4 show an enlarged plan view of the flexible arm 21 and the flexible arm 22 of FIG. 2, respectively. FIGS. 5 to 9 show an enlarged cross-sectional view in respective V-V line, VI-VI line, VII-VII line, IIX-IIX line, and IX-IX line of FIG. 2. As is obvious from their cross-sectional views, cross-section shapes of the grooves 26, 36 are rectangular, but they may be an inverted trapezoid with an upper portion of the groove open. A cross-sectional view of the weight 10 is not shown, but a cross-section shape of the groove 16 on the top surface of the weight 10 is a rectangle. The cross-section shape of the groove 16 thereon may be an inverted trapezoid shape with the top portion of the groove 16 open.

As shown in the cross-sectional views of FIGS. 5 to 7, formed is an electrically insulating layer 28 of silicon dioxide surrounding the silicon layer 24 (including the piezo sub-resistors Z1a, X1a, X1b, Z1b as shown in FIG. 5 and the high concentration diffusion layer Z1c as shown in FIG. 6) constituting the flexible arm 21. Since the single-crystal silicon constituting the flexible arm is usually N-type or P-type and has small electric resistivity of 1 to 100Ω·cm, it is necessary to form the electrically insulating layer 28 on a bottom and side wall of the groove 26 in which the metal wire 25 is disposed and to insulate the metal wire 25 from the silicon layer 24. The electrically insulating layer 28 has a thickness of 0.1 μm, but may have a thickness of 0.02 to 0.8 μm. The metal wire 25 of aluminum formed by sputtering is put in the groove 26. In a connection portion of the piezo sub-resistor with the metal wire 25, e.g. in a left end of the piezo sub-resistor X1a of FIG. 3, a through hole is formed in the electrically insulating layer 28 on an end of the piezo sub-resistor to connect, and then a metal wire 25 of aluminum is formed by sputtering, so that the connection of the piezo sub-resistor with the metal wire 25 can be insured. In this EXAMPLE, the groove 26 has a bottom width of 4 μm and a depth of 0.3 μm. Since the electrically insulating layer 28 is also formed on the silicon layer 24 of the flexible arm 21, the groove 26 has a depth of 0.3 μm from a top surface of the electrically insulating layer 28. Since the metal wire 25 having a width of 3 μm and a thickness of 0.2 μm is formed in the groove 26, a top surface of the metal wire 25 is 0.1 μm lower than the top surface of the electrically insulating layer 28 that is on the top surface of the flexible arm 21. In the present invention, the top surface of the metal wire 25 is preferably at least 0.05 μm lower than the top surface of the electrically insulating layer 28 of the flexible arm. If the top surface of the metal wire 25 is at least 0.05 μm lower than the top surface of the electrically insulating layer 28 of the flexible arm, the metal wire 25 does not make contact with the upper regulation plate 60 when the flexible arm is deformed. There in no problem associated with preventing contact of the metal wire 25 with the upper regulation plate 60 even if the top surface of the metal wire 25 is lowered at any depth from the top surface of the flexible arm. However, it is necessary to increase the depth of the groove 26 to lower it. Therefore, it is preferable that the depth from the top surface of the flexible arm to the top of the metal wire 25 is within 0.5 μm.

In this EXAMPLE, the groove 26 has a depth of 0.3 μm. The flexible arm is formed of an N-type silicon single crystal layer, i.e. silicon layer having a thickness of 6 μm covering the SiO2 layer. A ratio of the depth of the groove to the thickness of the flexible arm is approximately 5%. In the present invention, the ratio of the depth of the groove to the thickness of the flexible arm is preferably 15% or less. If this ratio is more than 15%, the strength of the flexible arm decreases.

As above described, the metal wire 25 having the width of 3 μm is formed in the groove 26 having the bottom width of 4 μm. When the metal wire has contact with the side wall of the groove, a stress occurs in the metal wire by temperature change and the metal wire is disposed in a thin region of the electrically insulating layer at a corner of the bottom of the groove, which should be preferably avoided. Accordingly, in the present invention, a ratio of the bottom width of the groove to the width of the metal wire is preferably 110% or more.

As shown in a cross-sectional view of FIG. 6, though the groove 26 is formed across the high concentration diffusion layer Z1c, since a depth of the high concentration diffusion layer Z1c, formed in the silicon layer 24, from the top surface of the flexible arm is 1 to 1.5 μm, which is considerably larger than a depth of the groove 26, e.g. 0.3 μm, the high concentration diffusion layer Z1c dose not cut by the groove 26. Moreover, since the electrically insulating layer 28 is provided between the high concentration diffusion layer Z1c and the metal wire 25, electrical insulation is insured therebetween.

As shown in FIGS. 4 and 8, the flexible arm 22 in the Y-axis direction is provided with two piezo-resistors Y1, Y2 (piezo sub-resistors Y1a, Y1b, Y2a, Y2b) and two metal wires 25. Since FIGS. 4 and 8 illustrating the flexible arm 22 are the same as FIGS. 3 and 5 illustrating the flexible arm 21 in the X-axis direction except the number of the piezo sub-resistors and the number of metal wires, its explanation will be omitted.

The weight 10 in the center of the acceleration sensor 100 is composed of the SOI wafer where the Si wafer is covered with the SiO2 insulating layer and the N-type silicon single crystal layer (silicon layer). An electrically insulating layer is formed on a top surface of the silicon layer. As shown in FIG. 2, FIG. 3, FIG. 4 and FIG. 10, the metal wire on the flexible arm extends to the top surface of the weight 10, and then is connected with the metal wire and/or the high concentration diffusion layer on the top surface of the weight 10. The groove 16 is formed along a section of the metal wires on the weight 10, and the metal wire 25 is put therein. In this EXAMPLE, the groove is formed in the silicon layer on the weight. An electrically insulating layer is provided on both inner side walls and a bottom surface of the groove 16, so that the metal wire and the silicon layer are electrically insulated from each other by the electrically insulating layer. When an acceleration is applied to the acceleration sensor, the top surface of the weight 10 of the acceleration sensor 100 is most likely to collide with the upper regulation plate. Therefore, the top surface of the metal wire on the top surface of the weight is lower than the top surface of the weight. In the top surface of the weight as well as in the top surface of the flexible arm, it is preferable that the top surface of the metal wire is at least 0.05 μm lower than the top surface of the electrically insulating layer of the weight.

In the section in which the metal wire 25 is drawn out to the top surface of the support frame 30, as a cross-section of the support frame shown in FIG. 9, a broad groove 36 receiving a plurality of metal wires 25 may be provided, if desired. As flexible arms 21, 22 shown in FIGS. 3 to 8, each flexible arm has a structure symmetric with respect to a centerline CL extending in the length direction thereof. As can be understood from an arrangement of the metal wires 25 of FIG. 3, either a top metal wire or a second metal wire from the top metal wire is sufficient for electrical wiring, but two metal wires are respectively arranged on both sides of the centerline CL so as to have a structure symmetric with respect to centerline CL. The same applies to the flexible arm 21′ arranged on a right side in FIG. 2.

In the acceleration sensor 100 of EXAMPLE 1 described herein, since the metal wire on the weight and the flexible arm is put in the grooves formed in the weight or the flexible arm as well as the top surface of the metal wire put in the groove is lower than the top surface of the weight and the top surface of the flexible arm, even when the weight and the flexible arm collide violently with the upper regulation plate by an excessive acceleration or impact applied to the acceleration sensor, deformation in the metal wire does not occur and thus an offset voltage does not occur.

### Example 2

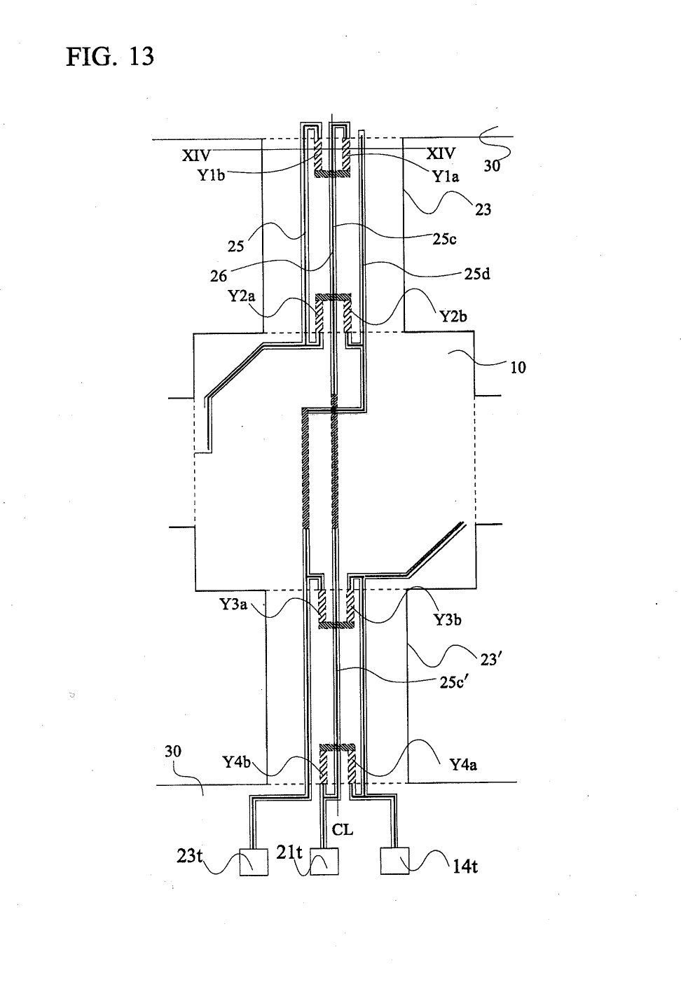

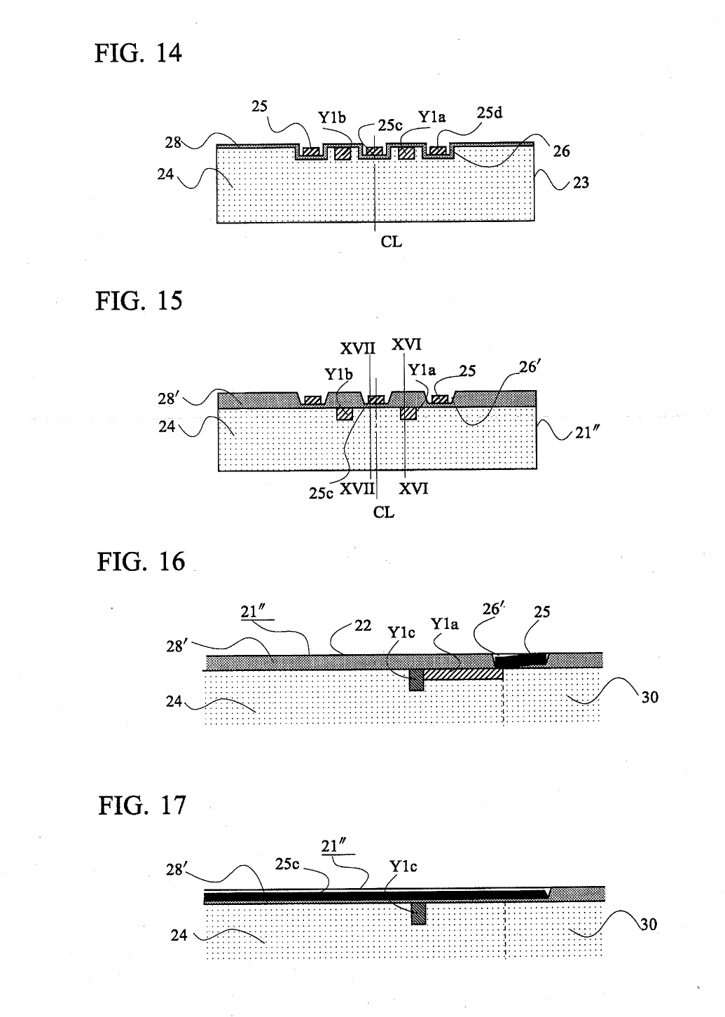

An acceleration sensor of EXAMPLE 2 according to the present invention will be described with reference to FIGS. 13 and 14. The acceleration sensor of EXAMPLE 2 has flexible arms 23, 23′ in the Y-axis direction as shown in FIGS. 13 and 14, instead of the flexible arms 22, 22′ in the Y-axis direction that is included in the acceleration sensor 100 of EXAMPLE 1. Two flexible arms 23, 23′ as shown in FIG. 13 have metal wires 25c, 25c′ arranged in grooves 26 along their centerline CL. A terminal on a support frame side of a piezo sub-resistor Y1a is connected, through the metal wire 25c along the centerline CL of the flexible arm 23 and then through the metal wire 25c′ along the centerline of the flexible arm 23′, to a sensor terminal 21t formed on an opposite support frame 30. A metal wire 25d on a right side of the flexible arm 23 is a dummy, and one end of the metal wire 25d is opened. The grooves 26 and metal wires 25, 25c, 25c′, 25d formed on the two flexible arms 23, 23′ are symmetric with respect to the centerline CL of the flexible arms 23, 23′. In EXAMPLE 1, the metal wire drawn out from a terminal on a support frame side of the piezo sub-resistor Y1a travels halfway around the acceleration sensor on the support frame 30 and then is connected to the sensor terminal 21t, on the other hand, in EXAMPLE 2, the metal wire drawn out from the terminal on the support frame side of the piezo sub-resistor Y1a is connected, through and on the two flexible arms 23, 23′ extending in the Y-axis direction, to the sensor terminal 21t.

### Example 3

Since an appearance of an acceleration sensor of EXAMPLE 3 is the same as shown in FIG. 1, the acceleration sensor will be described with reference to FIG. 1. The acceleration sensor of EXAMPLE 3 has an electrically insulating layer 28′ of silicon dioxide having a thickness of 0.8 μm on a top surface of a silicon layer 24, and a groove 26′ is formed in the electrically insulating layer 28′. FIG. 15 shows a cross-sectional view of the flexible arm 21″ extending in the Y-axis direction of the acceleration sensor. The groove 26′ has a shape of an inverted trapezoid having a bottom width of 6 μm and a depth of 0.4 μm, in which a metal wire 25 having a width of 3 μm and a thickness of 0.15 μm is provided. A top surface of the metal wire 25 is 0.25 μm lower than a top surface of the electrically insulating layer 28′. Also at a bottom of the groove 26′, there is the electrically insulating layer 28′ having a thickness of 0.4 μm between the bottom of the groove 26′ and the silicon layer 24, so that the metal wire 25 and the silicon layer 24 are electrically insulated from each other. Piezo sub-resistors Y1a, Y1b are formed adjacent to the top surface of the silicon layer 24, and a top of the piezo sub-resistors Y1a, Y1b are also covered with the electrically insulating layer 28′. As is the case with the flexible arm 21″, the electrically insulating layer 28′ of silicon dioxide having a thickness of 0.8 μm is formed on a top surface of a weight thereof, a groove is formed in the electrically insulating layer 28′, and the metal wire is disposed in the groove. The top surface of the metal wire in a top surface of the weight is 0.25 μm lower than the top of the electrically insulating layer.

FIG. 16 shows a longitudinal sectional view taken along XVI-XVI line of FIG. 15, and FIG. 17 shows a longitudinal sectional view taken along XVII-XVII line of FIG. 15. As shown in FIG. 16, at an end on a side of the support frame 30 of the piezo sub-resistor Y1a, a through hole is formed in the electrically insulating layer 28′ located on the piezo sub-resistor Y1a and a part of a bottom of the metal wire 25 formed in the groove 26′ in the electrically insulating layer 28′ is connected to the end of the piezo sub-resistor Y1a via the through hole. As shown in this figure, the top surface of the metal wire 25 is lower than the top surface of the electrically insulating layer 28′ at the end on the side of the support frame 30 of the piezo sub-resistor Y1a, on the other hand, the top surface of the metal wire 25 is at the same level as the top surface of the electrically insulating layer 28′ on a center side of the support frame 30. The weight and the flexible arm are displaced by an externally-applied acceleration, but the support frame 30 is not displaced. Therefore, even when the top surface of the metal wire 25 is at the same level as the top surface of the electrically insulating layer 28′ on the support frame 30, the metal wire 25 does not collide with the upper regulation plate in an area of the support frame 30. FIG. 17 is a longitudinal sectional view of the central metal wire 25c, and shows that the electrically insulating layer 28′ lies between the high concentration diffusion layer Y1c connecting two piezo sub-resistors Y1a and Y1b and the metal wire 25c.

### Example 4

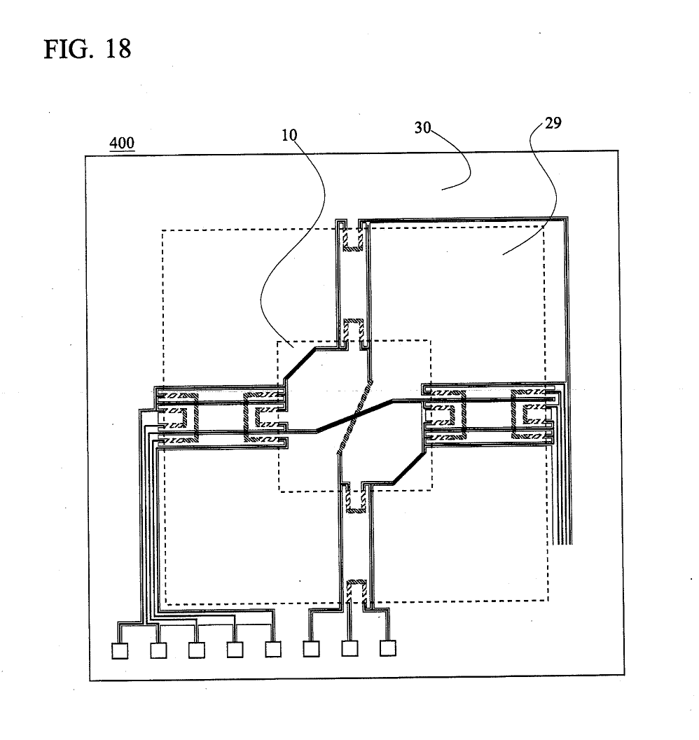

FIG. 18 shows a plan view of an acceleration sensor 400 of EXAMPLE 4. The acceleration sensor 400 has a diaphragm 29 as a flexible portion, and a weight 10 is held in a center of a support frame 30 by the diaphragm 29. Since the acceleration sensor 400 having the diaphragm 29 as the flexible portion instead of the flexible arms also serves as the acceleration sensor 100 of EXAMPLE 1, its detailed explanation will be omitted.

### Example 5

One hundred acceleration sensor devices, each of which comprising the acceleration sensor of EXAMPLE 1, as well as one hundred acceleration sensor devices, each of which comprising conventional acceleration sensor with no groove on a top surface of the acceleration sensor and with a metal wire disposed on a top surface of a weight and a top surface of flexible arm thereof were produced. For their samples, following steps were performed: (a) measurement of an offset voltage (measurement of an output voltage with no applied acceleration); (b) application of an impact; and then (c) measurement of an offset voltage. In the measurement of the offset voltage after the application of the impact, samples in which the offset voltage was changed by ±10% or more as compared with an initial value were disassembled and then a state of a metal wire thereof was inspected. For samples in which the offset voltage was changed by less than ±10%, application of an impact and measurement of offset voltage were repeated 50 times. In the impact test, the acceleration sensor device is fixed on an iron jig having a thickness of 2 mm, and was naturally dropped from a height of 1 m on a wooden board having a thickness of 100 mm, so that an impact of 1500 to 2000 G was applied thereto. A direction of impact was Z-axis of the acceleration sensor.

In the acceleration sensor device of EXAMPLE 1, even when the impact tests were repeated 50 times, there was no acceleration sensor device in which the offset voltage was changed by ±10% or more. However, in six of the conventional acceleration sensor devices, the offset voltage fluctuated by more than ±10%. When these six acceleration sensor devices ware disassembled and inspected, all the metal wires was partially deformed. In five of them, metal wires were deformed on the flexible arm in a region adjacent to the weight, and in one of them, the metal wire on the weight was deformed. From this result, it can be confirmed that in the acceleration sensor according to the present invention, even when an excessive impact was applied, deformation in the metal wire does not occur, and thus occurrence of an offset voltage can be prevented.

One hundred acceleration sensor devices with an IC chip as the upper regulation plate using the acceleration sensor of EXAMPLE 1 were produced, and when an excessive acceleration was applied, whether or not a latch-up phenomenon occurred was evaluated. The same impact test as above was performed, confirming either a presence or absence of a latch-up phenomenon by measuring the output thereof. Even when impact tests were repeated 10 times, the latch-up phenomenon did not occur. From this, in the acceleration sensor according to the present invention, since the acceleration sensor had the structure that the metal wire did not make contact with the upper regulation plate, not only occurrence of an offset voltage depending on deformation of the metal wire, but also occurrence of a latch-up phenomenon can be also prevented.

### INDUSTRIAL APPLICABILITY

The acceleration sensor for detecting an acceleration with the piezo-resistors is broadly used for automobiles, aircraft, home electric appliances, industrial machinery and the like. Even when an acceleration is not applied to the acceleration sensor, an output occurs. If the offset voltage is constant, the output can be canceled using a compensation circuit. However, when an excessive impact is applied to the acceleration sensor, the offset voltage may fluctuate. Since the acceleration sensor according to the present invention has a structure in which the metal wires on the weight or the flexible portion are placed in the groove or the groove formed on the flexible portion so that the metal wire does not collide with the upper regulation plate even when the weight collides with the upper regulation plate, fluctuation in the offset voltage can be prevented. The acceleration sensor having such structure is needed in industry.

1. An acceleration sensor comprising:
a weight in a center of the acceleration sensor,
a support frame surrounding the weight and being at a predetermined distance from the weight,
a flexible portion bridging an upper portion of the weight and an upper portion of the support frame and hanging the weight,
a plurality of piezo-resistors formed in the flexible portion and adjacent to a top surface of the flexible portion,
sensor terminals provided on a top surface of the support frame, and
metal wires connecting between the piezo-resistors or between the piezo-resistors and the sensor terminals,
wherein a part of the metal wires disposed on the flexible portion is put in a groove having a rectangular cross-section or an inverted trapezoidal cross-section formed on the top surface of the flexible portion, and top surfaces of the metal wires put in the groove formed on the top surface of the flexible portion are lower than the top surface of the flexible portion.

2. An acceleration sensor as set forth in claim 1, wherein a part of the metal wires disposed on a top surface of the weight is put in a groove having a rectangular cross-section or an inverted trapezoidal cross-section formed on the top surface of the weight, and top surfaces of the metal wires put in the groove formed on the top surface of the weight are lower than the top surface of the flexible portion.

3. An acceleration sensor as set forth in claim 1, wherein a part of the metal wires which is on a weight side from an end on a support frame side of a piezo-resistor disposed on the side of the support frame among the plurality of piezo-resistors has a top surface lower than the top surface of the flexible portion.

4. An acceleration sensor as set forth in claim 1, wherein top surfaces of the metal wires put in the groove formed on the top surface of the flexible portion are 0.05 μm to 0.5 μm lower than the top surface of the flexible portion.

5. An acceleration sensor as set forth in claim 1, wherein the flexible arms are composed of a silicon layer and an electrically insulating layer covering the silicon layer, and the electrically insulating layer covers the top surface of the flexible portion and both inner side walls and a bottom surface of the groove.

6. An acceleration sensor as set forth in claim 5, wherein the groove is formed on the silicon layer.

7. An acceleration sensor as set forth in claim 5, wherein the groove formed on the top surface of the flexible portion is formed in the electrically insulating layer covering the silicon layer.

8. An acceleration sensor as set forth in claim 1, wherein the groove on the top surface of the flexible portion extends to the top surface of the weight and to the top surface of the support frame.

9. An acceleration sensor as set forth in claim 8, wherein a plurality of metal wires are formed in a part of the groove on the top surface of the weight or the support frame.

10. An acceleration sensor as set forth in claim 2, wherein a top surface of the metal wires disposed in the groove formed on the top surface of the weight is at least 0.05 μm lower than the top surface of the weight.

11. An acceleration sensor as set forth in claim 2, wherein the weight has a silicon layer and an electrically insulating layer covering the silicon layer, and the electrically insulating layer covers both inner side walls and a bottom surface of a groove formed on the top surface of the weight.

12. An acceleration sensor as set forth in claim 11, wherein the groove of the top surface of the weight is formed on the top surface of the silicon layer.

13. An acceleration sensor as set forth in claim 11, wherein the groove of the top surface of the weight is formed on the electrically insulating layer covering the silicon layer.

14. An acceleration sensor as set forth in claim 1, wherein the flexible portion is composed of a plurality of flexible arms bridging the upper portion of the weight and the upper portion of the support frame,
each of the plurality of flexible arms has at least one of the grooves formed on the flexible portion, is constituted of a silicon layer and an electrically insulating layer covering the silicon layer, and the electrically insulating layer covers both inner side walls and a bottom surface, and
each of the plurality of flexible arms is structurally symmetric with respect to a centerline extending in a longitudinal direction of the flexible arm.

15. An acceleration sensor as set forth in claim 14, wherein each of the plurality of flexible arms has at least two grooves, and the piezo-resistors are located between the grooves on the silicon layer.
